(19) United States
(12) Patent Application Publication
(10) Pub. No.: US 2023/0219794 A1
(43) Pub. Date: Jul. 13, 2023

(54) Power Winch Dual-spring Brake Device

(71) Applicant: Comeup Industries Inc., New Taipei City (TW)

(72) Inventor: Shih Jyi Huang, New Taipei City (TW)

(21) Appl. No.: 17/574,678

(22) Filed: Jan. 13, 2022

(51) Int. Cl. B66D 1/14; B66D 1/12

(52) U.S. Cl. CPC B66D 1/14; B66D 1/12

(57) ABSTRACT

A power winch dual-spring brake device is a brake device installed in a rope wheel of a power winch includes a brake spring composed of a first brake spring and a second brake spring for producing a braking effect and a dual-spring mode of the mutual embedment in the dual-spring wire interval can reduce the possibility of deformation when force is exerted on a latch end, while reducing the possibility of generating high temperature and elastic fatigue, being broken or getting stuck to significantly improve the safety of use of the power winch.

### BACKGROUND OF THE INVENTION

### Field of the Invention

The present invention relates to a power winch dual-spring brake device, and more particularly to the power winch dual-spring brake device that can improve the safety of use by a dual-spring module plugged and embedded between dual-spring wires.

### Description of the Related Art

Power winch is a power tool used to lift a load up and down or drag the load to move near and away. For example, a “lifting hoist” used for lifting cargos or heavy objects for high-rise buildings is one of the common power winches, and a “rope hoist” installed in front of a jeep or onto an off-road vehicle for towing other vehicles or objects or rescuing other people is another kind of power winch. The operation principle of the power winch relies on a power source (such as power motor or an electric motor) that outputs a transmission power to control the winch to be operated in a forward or reverse direction. After a deceleration mechanism, a rope wheel is driven to perform a forward rotation or a reverse rotation in order to release or retract a rope (including but not limited to steel rope or synthetic rope), and the front end of the rope having a heavy-duty hook for hooking and hanging a load (such as a heavy object, another other, another object, etc.) in order to move the load.

The assembly of the traditional power winch must have a brake device provided for stopping the power transmission immediately during the power transmission process when necessary (such as pressing a stop button or encountering a power failure in order to ensure the safety of people and machine. It is known that there are many patents for the brake device of the power winch. Among them, the R.O.C. Patent 095217786/M308950 entitled “Power winch brake device” is related to a brake device of a rope wheel of the power winch as shown in FIG. 1, and the brake device of M308950 includes: a first drive block 1 with an end (outer end) connected to a motor (power source) through a bump 11 for receiving power and the other end (inner end) having two symmetrical protruding columns 1A, 1B, and each end of the protruding columns 1A, 1B having a stepped notch 1A1, 1B1, and an accommodating space 12 disposed around the periphery of the protruding column 1A, 1B; a second drive block 2, having two symmetrical protruding columns 2A, 2B facing an end (inner end) of the first drive block 1 and plugged (but not tightly fitted) into the accommodating space 12 of the first drive block 1, and each end of the second drive block 2 also having a stepped notch 2A1, 2B1, and the other end (outer end) of the second drive block 2 having a polygonal slot 22 provided for plugging and connecting a shaft in the shape of the polygonal slot; a brake spring 3, sheathed on a common outer periphery of the protruding column 1A, 1B of the first drive block 1 and the protruding column 2A, 2B of the second drive block 2, and each of the two ends having an inwardly bent latch end 31, 32, and the latch ends 31, 32 having an angle difference (such as 120°).

In the action of the conventional brake device as disclosed in R.O.C. Pat. No. M308950, when the power source of the power winch outputs a forward rotation power (i.e. releasing a steel rope by power to hoist a heavy object to descend), the transmission of power will drive the first drive block 1 to rotate, such that the latch end 31 of the brake spring 3 will be pushed by the notch A1 of the first drive block 1, and the protruding column 1A together with the latch end 31 will push the protruding column 2A of the second drive block 2 to rotate, while the protruding column 1B of the first drive block 1 is pushing the protruding column 2B of the second drive block 2 to rotate together; when the power source of the power winch outputs a reverse rotation power (i.e. retracting the steel rope by power to hoist the heavy object to ascend), the transmission of power will similarly drive the first drive block 1 to rotate (in an opposite rotation direction), and the protruding column 1B of the first drive block 1 will push the protruding column 2A of the second drive block 2 to move instead, so as to push the latch end 32 of the brake spring 3 into the notch 2A1 of the protruding column 2A. In the above two actions of the power source that outputs a forward rotation power and a reverse rotation power, since the latch ends 31, 32 of the brake spring 3 will be pushed by the notches 1A1, 2A1 of the first drive block 1 respectively, the elastic wire will be slightly contracted inward, and a gap will be produced between the brake spring 3 and an inner wall of a bushing ring to define a state without the braking effect, so as to hoist the heavy object to descend or ascend successfully.

When the power source of the power winch is disconnected (by pressing a stop button or encountering a sudden power failure, the hoisted heavy object has a downward pulling force, so that the second drive block 2 will immediately receive a pulling force returned from the rope wheel to rotate the second drive block 2, and the latch end 32 of the brake spring 3 will be pushed by the notch 2A1 of the protruding column 2A instantaneously, while the protruding column 2A together with the latch end 32 push the protruding column 1B of the first drive block 1 to move, and the protruding column 2B of the second drive block 2 will push the protruding column 1A of the first drive block 1 to move. During the moment of action, the outer side of the latch end 32 of the brake spring 3 is pushed by the protruding column 2A of the second drive block 2, such that the brake spring 3 produces an elastic wire expansion to contact with the inner wall of the bushing ring quickly, so as to achieve the braking effect.

In the aforementioned conventional brake device, a single brake spring 3 is used to achieve the expansion and braking effects in a short time, but after a long time of use, the reaction may have the following drawbacks:

1. In general, only the elastic wire having a start end situated near the position of about 1 ˜2 coils is in contact with the inner wall of the bushing ring during the braking effect, so that in a long-term use, the elastic wire of the brake spring 3 will have non-uniform wear, and the elastic wire often worn and fatigued is subjected to force more frequently, thereby resulting in a frequent heated and damaged by a too-high temperature, and even an instantaneous break or jam of the elastic wire, or a public safety accident in a serious scenario.
2. During use, the bent latch ends 31, 32 are easily deformed by excessive forces, and the braking effect will be reduced, and even the bent position may be broken or stuck easily, which will cause panics to users.

### SUMMARY OF THE INVENTION

In view of the aforementioned drawbacks, the inventor of the present invention based on years of experience in the related industry to conduct extensive research and experiment, and finally developed a more reliable and practical brake device for power winches to overcome the drawbacks of the prior art.

Therefore, it is a primary objective of the present invention to provide a power winch dual-spring brake device capable of reducing the stress and deformation that may produce high temperature, elastic fatigue, fracture or jam to improve the safety of use.

To achieve the above-mentioned objective, the present invention provides a power winch dual-spring brake device, comprising a power source, for driving a rope wheel to perform a forward rotation or a reverse rotation to release or retract a rope after outputting a power transmission to operate a deceleration device, and the rope wheel being disposed at a horizontal middle position of a support frame, and the power source being installed on a side of the support frame, and the deceleration device being installed on the other side of the support frame; the rope wheel having a brake device installed therein, and comprising a first drive block, a second drive block, and a brake spring assembly, wherein the first drive block has an engagement bump disposed on an outer side thereof and engaged with a clamping slot formed at an end of a force output shaft of the power source, and two symmetrical protruding columns disposed on an inner side of the first drive block, and each end of the protruding column has a notch, and an accommodating space formed around the periphery of the protruding column; an end surface of the second drive block facing the first drive block has two symmetrical protruding columns, and the protruding columns are non-tightly plugged into the accommodating space in the first drive block, and each end of the second drive block has a notch, characterized in that the brake spring is an assembly of a first brake spring and a second brake spring, and each of the two ends of the first brake spring has an inwardly bent latch end, and there is an angle difference between the latch ends; each of the two ends of the second brake spring has an inwardly bent latch end, and there is an angle difference between the latch ends of the second brake spring, and the first brake spring and the second brake spring have a wire interval corresponding to a wire width, and the number of wire coils are equal, and the wire of the first brake spring is aligned precisely with the wire interval of the second brake spring, while the wire of the second brake spring is aligned precisely with and plugged into the wire interval of the first brake spring to form a brake spring of the brake device.

According to the above-mentioned power winch dual-spring brake device, the latch end of the first brake spring is disposed at a distance from the latch end of the second brake spring.

According to the above-mentioned power winch dual-spring brake device, the latch end of the first brake spring is disposed adjacent to the latch end of the second brake spring.

### BRIEF DESCRIPTION OF THE DRAWINGS

FIG. 1 is a perspective view of a prior art;

FIG. 2 is a perspective view of a first embodiment of the present invention;

FIG. 3 is a cross-sectional view of a part of the first embodiment of the present invention;

FIG. 4 is an exploded view of a part of the first embodiment of the present invention as depicted in FIG. 1;

FIG. 5 is an exploded view of a part of the first embodiment of the present invention as depicted in FIG. 2;

FIG. 6 is a schematic view showing the operation of embedding the dual brake springs of the first embodiment of the present invention;

FIG. 7 is an exploded view of a brake device of the first embodiment of the present invention;

FIG. 8 is a schematic view showing the transmitting effect of the first embodiment of the present invention when a steel rope is retracted to hoist a heavy object;

FIG. 9 is a schematic view showing the braking effect of the first embodiment of the present invention when a steel rope is stopped from retracting to hoist a heavy object;

FIG. 10 is a schematic view showing the transmission effect when a steel rope is released to hoist a heavy object in accordance with the first embodiment of the present invention;

FIG. 11 is a schematic view showing the braking effect when a steel rope stops releasing to hoist a heavy object in accordance with the first embodiment of the present invention;

FIG. 12 is a first exploded view of a part of a second embodiment of the present invention;

FIG. 13 is a second exploded view of a part of the second embodiment of the present invention;

FIG. 14 is a schematic view showing the action of embedding and assembly a dual brake spring in accordance with the second embodiment of the present invention; and

FIG. 15 is an exploded view of a brake device of the second embodiment of the present invention.

### DETAILED DESCRIPTION OF THE PREFERRED EMBODIMENTS

The adopted technical means and achievable effects of the present invention will be apparent with the detailed description accompanied with related drawings of preferred embodiments as follows.

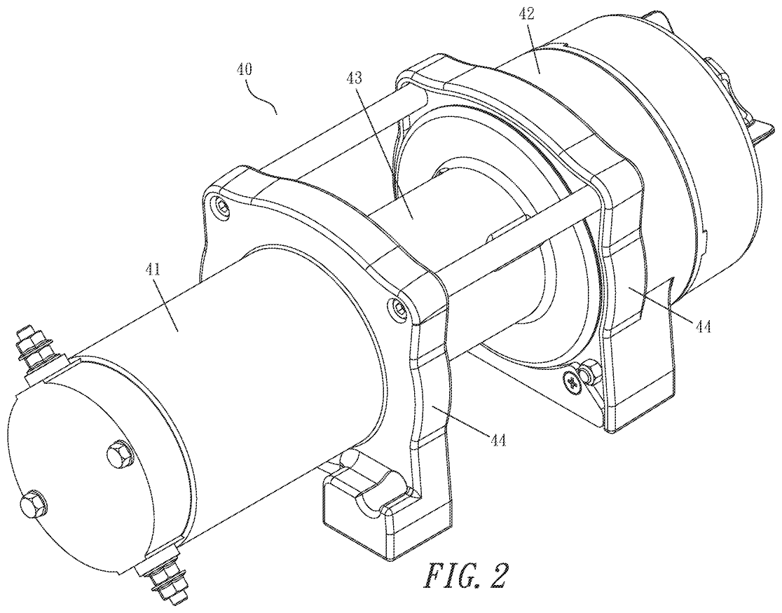

With reference to FIG. 2 for a power winch 40 in accordance with the first embodiment of the present invention, the power winch 40 includes a power source 41 (such as a power motor or an electric DC motor) for outputting a power transmitted to a deceleration device 42 to drive a rope wheel 43 to perform a forward rotation or a reverse rotation, so as to release or retract a rope as needed. For simplicity and clarity, the rope is not shown in the figure, and the rope wheel 43 is disposed at horizontal middle position of a support frame 44, and the power source 41 is installed on a side of the support frame 44, and the deceleration device 42 is installed on the other side of the support frame 44, and a power transmission is disposed between the power source 41 and the deceleration device 42 and passed through without touching the interior of a barrel shaft of the rope wheel 43, and then the deceleration device 42 substantially drives the whole rope wheel 43 to rotate, and the rope wheel 43 and the support frame 44 are connected by bearings to achieve the effect of maintaining the support frame 44 at a steady unmoved state while the rope wheel 43 is rotating.

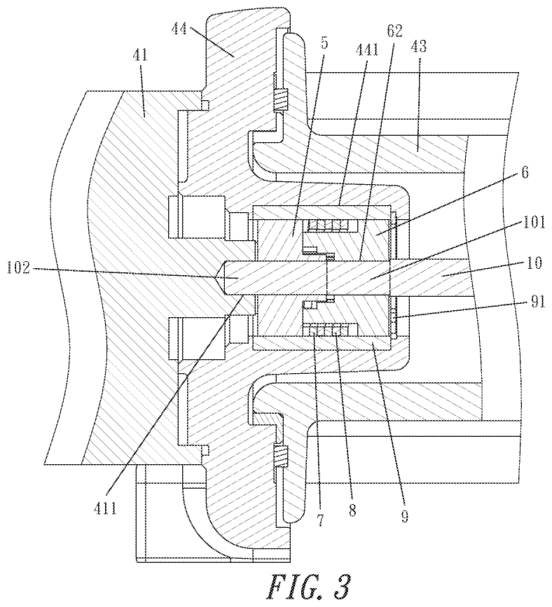

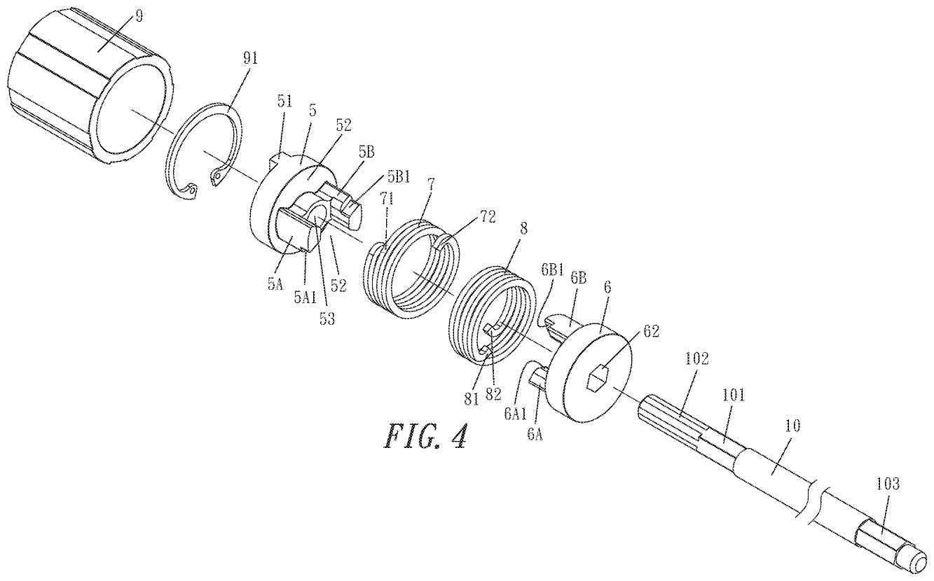

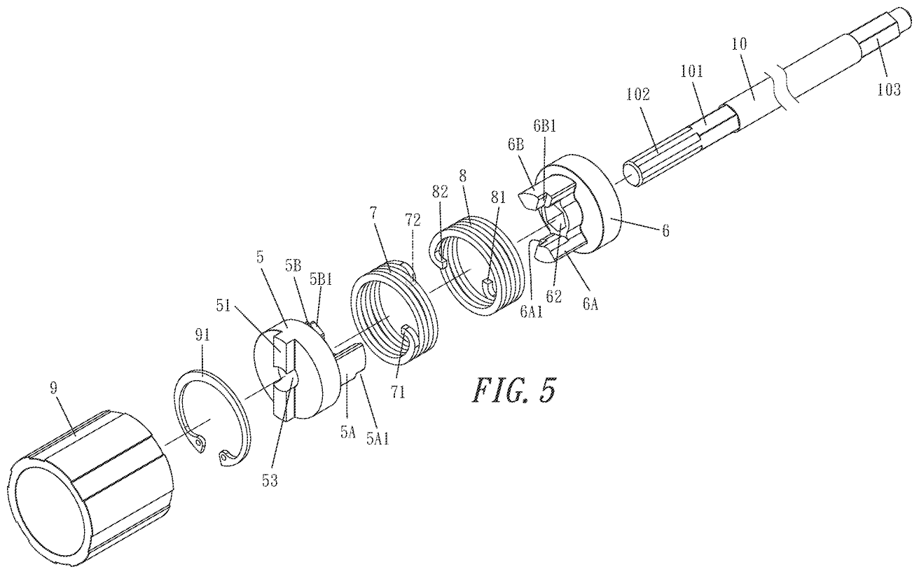

In FIGS. 3, 4 and 5, the power winch 40 inside the rope wheel 43 includes a “brake device” formed by a first drive block 5, a second drive block 6, a first brake spring 7, a second brake spring 8, a bushing ring 9 and a transmission shaft 10, wherein the first drive block 5 has an engagement bump 51 disposed on an outer side of the first drive block 5 and engaged with a clamping slot formed at an end of a force output shaft of the power source 41 for receiving the power transmitted from the power source 41, and an inner side of the first drive block 5 has two symmetrical protruding columns 5A, 5B, and each end of the protruding columns 5A, 5B has a stepped notch 5A1, 5B1, and an accommodating space 52 is formed around the periphery of the protruding column 5A, 5B, and the center of the first drive block 5 has a perforated hole 53 longitudinally penetrating both sides; an end surface (or inner end surface) of the second drive block 6 facing the first drive block 5 has two symmetrical protruding columns 6A, 6B plugged into the accommodating space 52 of the first drive block 5, and a gap is maintained between the protruding columns 5A, 5B; in other words, the accommodating space 52 is not completely filled or fitted tightly, and each end of the protruding columns 6A, 6B is also a stepped notch 6A1, 6B1, and the other end surface (or the outer end surface) has a polygonal slot 62 longitudinally penetrating both sides; each of the two ends of the first brake spring 7 has an inwardly bent latch end 71, 72 (which is commonly known as “spring foot” in the industry), and the latch ends 71, 72 have an angle difference (such as 270°); each of the two ends of the second brake spring 8 also has an inwardly bent latch end 81, 82, and the latch ends 81, 82 also have an angle difference (such as 270°), and the second brake spring 8 has a diameter equal to the diameter of the first brake spring 7; the bushing ring 9 is a hard rigid ring with a wear-resisting inner wall, a longitudinal length approximately equal to the length of the protruding column 5A (or 5B, 6A, 6B), and an internal diameter equal to the diameter of the first brake spring 7 (or second brake spring 8); the transmission shaft 10 is a long rod having a polygonal engagement junction 101 formed at an end section proximate to the power source 41 and a pressing end 102 is defined at the same end, and the other end is defined as an engagement end 103, and the polygonal cross-section of the engagement junction 101 is corresponsive to the polygonal slot 62, so that when the transmission shaft 10 is plugged and passed through the polygonal slot 62, the engagement junction 101 and the polygonal slot 62 can be engaged with each other, and the pressing end 102 of the transmission shaft 10 can be passed through (without touching) the perforated hole 53 of the first drive block 5 and then pressed into the a pressing slot 411 formed at an end of the force output shaft of the power source 41 to achieve the supporting and positioning effects as shown in FIG. 3. Since the pressing end 102 of the transmission shaft 10 is only loosely pressed and remained into the pressing slot 411, the transmission shaft 10 will not receive the transmission from the power source 41, but the engagement junction 101 of the transmission shaft 10 is engaged with the polygonal slot 62 of the second drive block 6, so that when the second drive block 6 is rotated, it will drive the transmission shaft 10 to rotate synchronously, and after the rod of the transmission shaft 10 is passed through (without touching) the rope wheel 43 in a direction away from the power source 41, the engagement end 103 of the transmission shaft 10 will be engaged with the deceleration device 42, and when the transmission shaft 10 is rotated, it will drive the deceleration device 42 to produce an action.

During assembling as shown FIG. 3, the support frame 44 proximate to the power source 41 is bent inwardly towards the interior of the rope wheel 43 to form an assembly space 441, an inner end of the assembly space 441 is plugged into a limit ring clip 91, the bushing ring 9 is accommodated in the assembly space 441 and attached to a ring wall to limit and fix the bushing ring 9 into a position, the assembly formed by the first drive block 5, the second drive block 6, the first brake spring 7, the second brake spring 8 and the transmission shaft 10 is accommodated into the bushing ring 9, and finally the power source 41 and the deceleration device 42 are assembled to complete the assembly of the power winch 40.

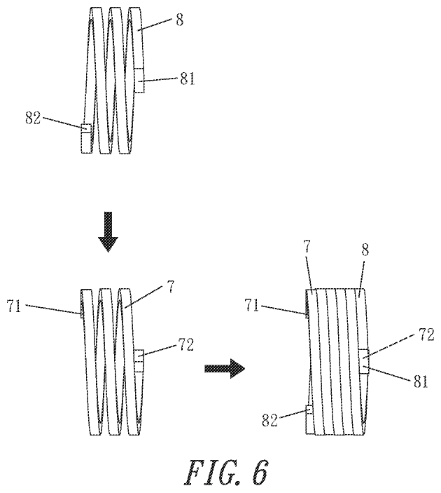

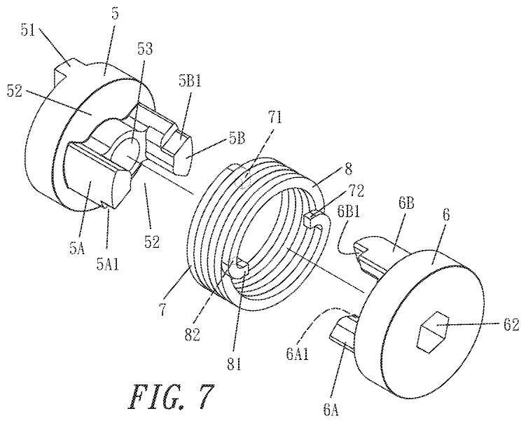

The major improvement of the present invention resides on that the power winch 40 is installed to the “brake device” inside the rope wheel 43, wherein the brake spring for producing the braking effect is formed by embedding the first brake spring 7 and the second brake spring 8 with each other. In FIG. 6, the first brake spring 7 and the second brake spring 8 are manufactured and formed separately, which are two standalone objects. In the manufacture, the first brake spring 7 and the second brake spring 8 have a wire interval corresponding to a wire width, and the numbers of wire coils are also equal. As indicated by the left small diagram of FIG. 6, wire of the second brake spring 8 is aligned precisely with the wire of the first brake spring 7, and the two are plugged into the wire interval as shown in the right small diagram of FIG. 6, wherein the latch end 71, 72 of the first brake spring 7 and the latch end 81, 82 of the second brake spring 8 are disposed with a distance apart from each other. FIG. 7 shows the exploded view of the first drive block 5, the second drive block 6 and the brake spring formed by embedding the first brake spring 7 and the second brake spring 8 with each other.

The effects of the present invention can be divided into “a transmission effect for hoisting the load when the steel rope is retracted”, “a braking effect for hoisting the load when the steel rope is stopped from being retracted”, “a transmission effect for hoisting the load when the steel rope is released” and “a braking effect for hoisting the load when the steel rope is stopped from being released” as described below:

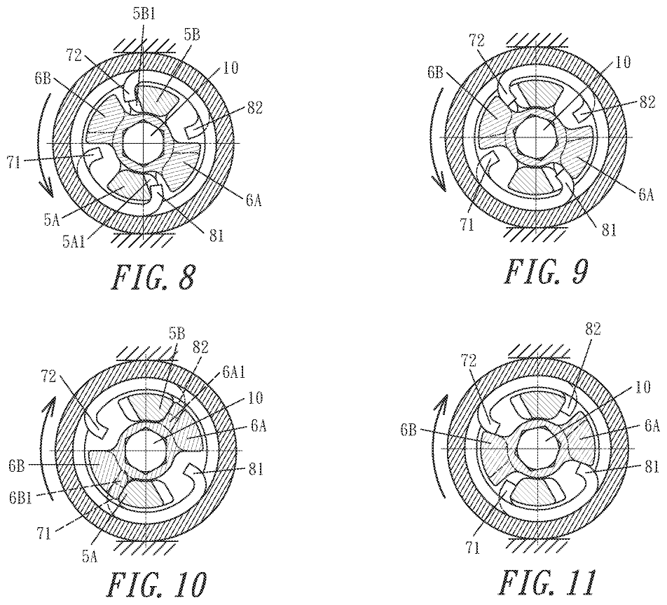

1. When the load is hoisted and the steel rope is retracted to move the load upward (or inward) as shown in FIG. 8, the power source 41 performs a forward rotation (which is a counterclockwise rotation in the figure) to drive the first drive block 5 to rotate synchronously, so that the notch 5A1 of the protruding column 5A of the first drive block 5 will instantaneously push the latch end 81 of the second brake spring 8 and the protruding column 6A of the second drive block 6 to rotate synchronously, while the notch 5B1 of another protruding column 5B will push the latch end 72 of the first brake spring 7 and the protruding column 6B of the second drive block 6 to rotate synchronously, and the rotation of the second drive block 6 will link the transmission shaft 10 to rotate synchronously and drive the deceleration device 42 to produce an action, and finally drive the rope wheel 43 to rotate in order to retract the steel rope.

2. When the load is hoisted and the steel rope is stopped from being retracted while pressing a stop button or encountering a sudden power failure as shown in FIG. 9 (compared with FIG. 8), the pulling force in the opposition direction of hoisting the load will immediately transmit the power to the second drive block 6 to perform a reverse rotation, so that the protruding column 6A of the second drive block 6 will instantaneously push (or impact) the latch end 81 in a reverse direction, while the protruding column 6B of the second drive block 6 also instantaneously push (or impact) the latch end 72, such that the first and second brake springs 7, 8 simultaneously having a wire expansion, and only a slight expansion can produce friction with the inner wall of the bushing ring 9 to achieve the braking effect and immediately stop the rotation of the second drive block 6.

3. When the load is hoisted and the steel rope is release to move the load downward (or outward) as shown in FIG. 10, the power source 41 performs a reverse rotation (which is a clockwise rotation as shown in the figure) to drive the first drive block 5 to rotate synchronously, so that the protruding column 5A of the first drive block 5 will immediately push the latch end 71 of the first brake spring 7 to be pressed into the notch 6B1 of the protruding column 6B of the second drive block 6, so as to push the protruding column 6B to rotate synchronously, while another protruding column 5B pushes the latch end 82 of the second brake spring 8 to be pressed into the notch 6A1 of the protruding column 6A of the second drive block 6 to immediately push the protruding column 6A to rotate synchronously and drive the deceleration device 42 to produce an action and finally drive the rope wheel 43 to rotate in order to release the steel rope.

4. When the load is hoisted and the steel rope is stopped from being released while pressing a stop button or encountering a sudden power failure as shown in FIG. 11 (compared with FIG. 10), the pulling force of hoisting the load will immediately transmit the power to the second drive block 6 to accelerate the rotation, so that the protruding column 6A of the second drive block 6 will instantaneously push (or impact) the latch end 81, while the protruding column 6B of the second drive block 6 will instantaneously push (or impact) the latch end 72, such that the first and second brake springs 7, 8 simultaneously having a wire expansion, and only a slight expansion can produce friction with the inner wall of the bushing ring 9 to achieve the braking effect, and immediately stop the rotation of the second drive block 6.

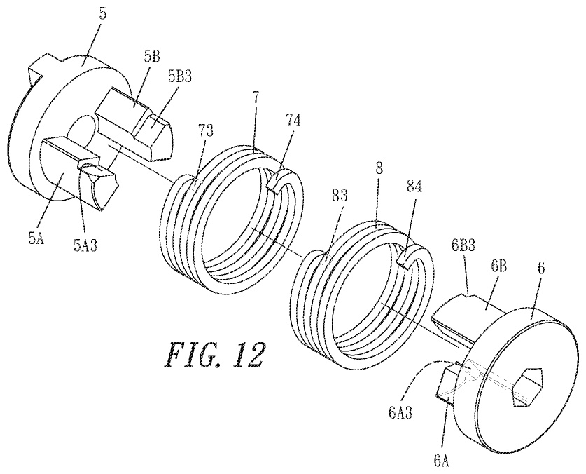

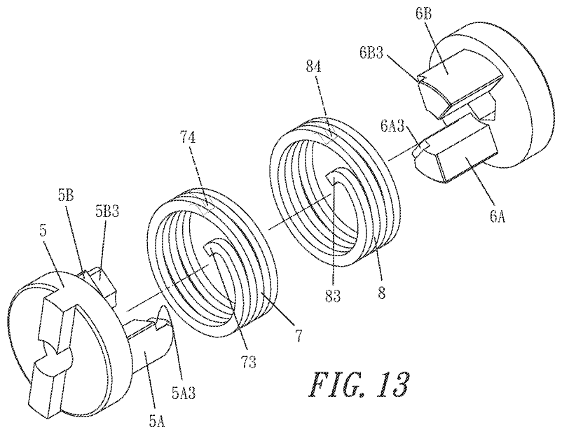

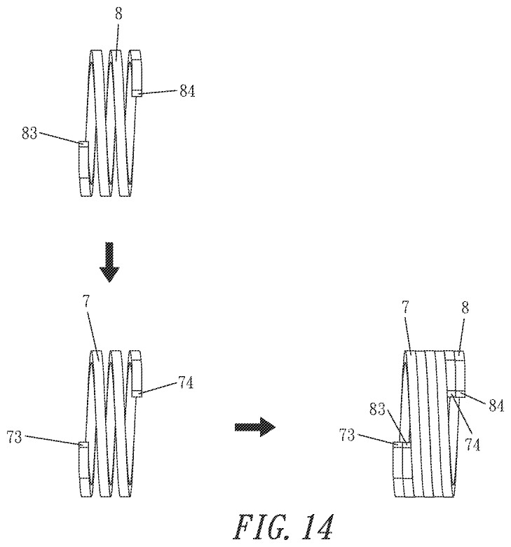

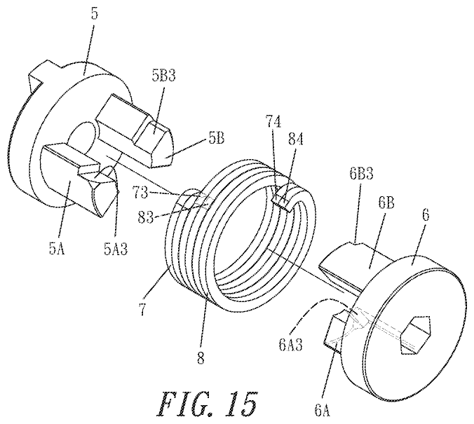

With reference to FIGS. 12 and 13 for the second embodiment of the present invention, the structure of a power winch 40 of the second embodiment is the same as that of the first embodiment, and the same components adopt the same respective numerals for the description of both embodiments. In the second embodiment, the “brake device” is also composed of a first drive block 5, a second drive block 6, a first brake spring 7, and a second brake spring 8, and the inner side of the first drive block 5 also has two symmetrical protruding columns 5A, 5B, and each end of the protruding columns 5A, 5B has a stepped notch 5A3, 5B3. Unlike the first embodiment, the notches 5A3, 5B3 of the second embodiment are configured to be facing each other, and the inner side of the second drive block 6 also has two symmetrical protruding columns 6A, 6B, and each end of the protruding columns 6A, 6B also has a stepped notch 6A3, 6B3. Unlike the first embodiment, the notches 6A3, 6B3 of the second embodiment are configured to be facing each other, and each of the two ends of the first brake spring 7 also has an inwardly bent latch end 73, 74, and each of the two ends of the second brake spring 8 also an inwardly bent latch end 83, 84. In the second embodiment, the first brake spring 7 and the second brake spring 8 are also manufactured separately, and the first brake spring 7 and the second brake spring 8 have a wire interval corresponding to the width of the wire, and the numbers of wire coils are also the same, and the wire of the second brake spring 8 is also aligned precisely with the wire of the first brake spring 7 and both wires are embedded into the wire interval. Unlike the first embodiment, the latch end 73 of the first brake spring 7 and the latch end 83 of the second brake spring 8 are arranged side by side with each other, while the latch end 74 of the first brake spring 7 and the latch end 84 of the second brake spring 8 are also arrange side by side with each other, so that the first brake spring 7 and the second brake spring 8 being separated from each other before the embedment are as shown in the left small diagram of FIG. 14, and then wire of the second brake spring 8 is aligned precisely with the wire of the first brake spring 7, and both wires are embedded into the wire interval as shown in the right small diagram of FIG. 14. FIG. 15 is the exploded view of the first drive block 5, the second drive block 6 and the brake spring formed by engaging the first brake spring 7 with the second brake spring 8.

During the use of the “brake device” of the second embodiment, when the load is hoisted and the steel rope is retracted to move the load upward (or inward), the transmission of power will drive the first drive block 5 to rotate, such that the notch 5B3 at the front end of the protruding column 5B of the first drive block 5 will simultaneously push the latch ends 74, 84 of the brake springs 7, 8 to push the protruding column 6B of the second drive block 6 to rotate synchronously, while the protruding column 5A of the first drive block 5 also pushes the protruding column 6A of the second drive block 6 to rotate together; when the load is hoisted and the steel rope is released to move the load downward (or outward), the transmission of power also drives the first drive block 1 to rotate (but in an opposite direction), so that the protruding column 5A of the first drive block 5 pushes the protruding column 6B of the second drive block 6 to move instead, and the latch ends 73, 83 of the brake springs 7, 8 are pressed and entered into the notch 6A3 of the protruding column 6A. in the aforementioned two actions of retracting and releasing the steel rope, the latch ends 74, 84 and the latch ends 73, 83 of the brake springs 7, 8 are pushed by the notch 5B3 of the first drive block 5 and the notch 6A3 of the second drive block 6 respectively, such that the elastic wire will be expanded slightly inward, so that a gap is produced between the brake springs 7 8 and the inner wall of the bushing ring 9 to define a state without any braking effect, so as to hoist the load to move successfully.

When the power source 41 is disconnected (by pressing stop button or encountering a power failure, the pulling force of hoisting the load will drive the second drive block 6 to rotate, and the latch ends 74, 84 of the brake springs 7, 8 will be pushed by the protruding column 6B, while the protruding column 6A together with the latch ends 73, 83 pushes the protruding column 5A of the first drive block 5 to move, and the protruding column 6B of the second drive block 6 pushes the protruding column 5B of the first drive block 5 to move. In the moment of the action, the outer sides of the latch ends 74, 84 of the brake springs 7, 8 are pushed by the protruding column 6B, such that the brake springs 7, 8 produce an elastic wire expansion to quickly produce a friction with the inner wall of the bushing ring 9, so as to achieve the braking effect.

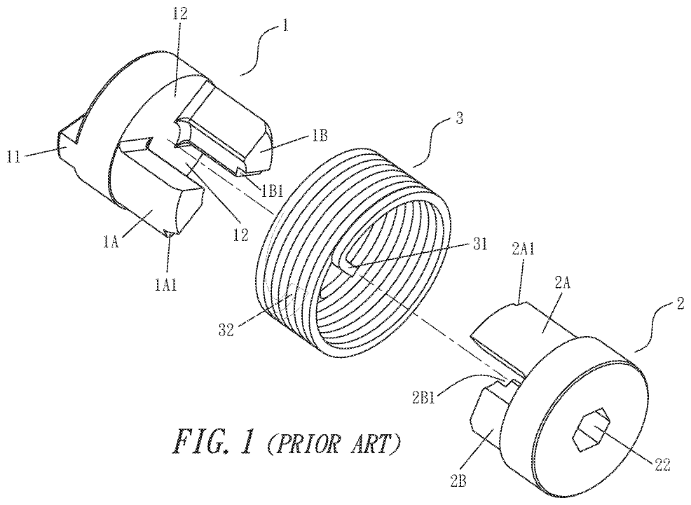

In summation of the description above, the major characteristic of the present invention resides on that the brake spring of the power winch is in a dual-spring mode formed by engaging and embedding the first brake spring 7 and the second brake spring 8 into the wire interval. Compared with the different structure and effects of the single-spring mode of the conventional brake spring 3 as shown in FIG. 1, the present invention has the following advantages:

1. The present invention uses the dual braking spring to achieve the braking effect, so that the number of spring coils used for the braking effect is at least twice as many as that of the prior art, the braking effect is relatively improved, and the spring is reduced during braking. The wear and tear of the wire will greatly reduce the possibility of causing high temperature, elastic fatigue and breakage or getting stuck, which can improve the safety of use significantly.

2. The present invention uses a dual brake spring for the braking effect, so that the number of latch ends (commonly known as “spring feet” in the industry) that bear the impact when the braking effect is generated has been doubled compared with the prior art, thereby reducing the possibility of receiving stress, deforming, breaking, or getting stuck to improve the safety of use significantly.

In summation of the description above, the electrical connector assembly of the present invention is novel and capable of achieving the expected functions and effects and complying with the patent application requirements, and thus is dully filed for patent application. While the present invention has been described by means of specific embodiments, numerous modifications and variations could be made thereto by those skilled in the art without departing from the scope and spirit of the invention set forth in the claim.

What is claimed is:

1. A power winch dual-spring brake device, comprising a power source, for driving a rope wheel to perform a forward rotation or a reverse rotation to release or retract a rope after outputting a power transmission to operate a deceleration device, and the rope wheel being disposed at a horizontal middle position of a support frame, and the power source being installed on a side of the support frame, and the deceleration device being installed on the other side of the support frame; the rope wheel having a brake device installed therein, and comprising a first drive block, a second drive block, and a brake spring assembly, wherein the first drive block has an engagement bump disposed on an outer side thereof and engaged with a clamping slot formed at an end of a force output shaft of the power source, and two symmetrical protruding columns disposed on an inner side of the first drive block, and each end of the protruding column has a notch, and an accommodating space formed around the periphery of the protruding column; an end surface of the second drive block facing the first drive block has two symmetrical protruding columns, and the protruding columns are non-tightly plugged into the accommodating space in the first drive block, and each end of the second drive block has a notch, characterized in that the brake spring is an assembly of a first brake spring and a second brake spring, and each of the two ends of the first brake spring has an inwardly bent latch end, and there is an angle difference between the latch ends; each of the two ends of the second brake spring has an inwardly bent latch end, and there is an angle difference between the latch ends of the second brake spring, and the first brake spring and the second brake spring have a wire interval corresponding to a wire width, and the number of wire coils are equal, and the wire of the first brake spring is aligned precisely with the wire interval of the second brake spring, while the wire of the second brake spring is aligned precisely with and plugged into the wire interval of the first brake spring to form a brake spring of the brake device.

2. The power winch dual-spring brake device according to claim 1, wherein the latch end of the first brake spring is disposed at a distance from the latch end of the second brake spring.

3. The power winch dual-spring brake device according to claim 1, wherein the latch end of the first brake spring is disposed adjacent to the latch end of the second brake spring.
